(19) United States
(12) Patent Application Publication
(10) Pub. No.: US 2022/0001468 A1
(43) Pub. Date: Jan. 6, 2022

(54) CUTTING TOOL AND CUTTER HEAD STRUCTURE THEREOF

(71) Applicant: CONPROFE TECHNOLOGY GROUP CO.,LTD., Guangdong (CN)

(72) Inventors: Bingjiang Yan, Guangdong (CN); Weiqiu Li, Guangdong (CN); Guoli Zhang, Guangdong (CN)

(73) Assignee: CONPROFE TECHNOLOGY GROUP CO.,LTD., Guangdong (CN)

(21) Appl. No.: 16/759,363

(22) PCT Filed: Dec. 19, 2019
(86) PCT No.: PCT/CN2019/126775

§ 371 Date: Apr. 27, 2020

(30) Foreign Application Priority Data
Aug. 26, 2019 (CN) 201910789384.2
Dec. 5, 2019 (CN) 201922157875.3

(51) Int. Cl. B23C 5/10

(52) U.S. Cl. CPC B23C 5/1018; B23C 2210/402

(57) ABSTRACT

A cutter head structure includes a cutting edge portion including a cutting body. An outer surface of the cutting body is a curved surface which protrudes forwardly. The outer surface of the cutting body is provided with a first cutting edge and at least two second cutting edges. The first cutting edge extends from one side of the cutting body to a top region of the cutting body and then to the other side of the cutting body. The second cutting edges are respectively disposed on both sides of the first cutting edge. First chip flutes are defined between the first cutting edge and the second cutting edges adjacent thereto, and each of the first chip flutes has a width gradually increasing from the top region to both ends of the cutting body.

### BACKGROUND

### Technical Field

The invention relates to the field of precision machining technology, in particular to a cutting tool and cutter head structure thereof.

### Description of Related Art

At present, a main cutting edge is disposed at a center point of the top portion of a conventional ball milling cutter. When milling a curved surface, the excess surface material of a workpiece is removed by pressing or cutting action at an apex of the main cutting edge. However, due to the concentrated force at the apex, the main cutting edge at the apex position is subjected to greater abrasion and the service life of the tool is limited. Besides, when workpieces are machined in batches, the machining is unstable, and surface roughness and profile of each workpiece are unstable. For this problem, secondary cutting edges are arranged at both sides of the main cutting edge to assist the main cutting edge to cut and press. However, because the cutting edges are concentrated in the top region of the tool, the cutting chip is not discharged smoothly, which not only causes concentrated processing heat, but also affects the machining accuracy of workpieces and processing stability.

### SUMMARY

An objective of the invention is to overcome the deficiencies of the prior art and provide a cutting tool capable of reducing tool wear to prolong the service life of the tool, ensuring the surface roughness of a machined workpiece, improving the processing stability, and improving the chip removal performance.

In order to achieve the above objective, a first aspect of the invention provides a cutter head structure including a cutting edge portion including a cutting body. An outer surface of the cutting body is a curved surface which protrudes forwardly, and the outer surface of the cutting body is provided with a first cutting edge and at least two second cutting edges. The first cutting edge extends from one side of the cutting body to a top region of the cutting body and then extends to the other side of the cutting body. The second cutting edges are respectively disposed at two sides of the first cutting edge. First chip flutes are defined between the first cutting edge and the second cutting edges adjacent thereto, and each of the first chip flutes has a width gradually increasing from the top region of the cutting body to both ends of the cutting body.

In a preferred embodiment, first chip flutes are defined between the first cutting edge and the second cutting edges adjacent thereto. The first cutting edge comprises a first segment, a middle segment, and a second segment connected in sequence. Edge widths of the second cutting edges, of the first segment, and of the second segment are greater than an edge width of the middle segment. Traditionally, most of excess material is removed by secondary cutting edges, and the remaining lesser excess material is subjected to extrusion processing by a main cutting edge, which will cause serious abrasion of the secondary cutting edges at both sides and lesser abrasion of the main cutting edge between the secondary cutting edges. Since the main cutting edge and the secondary cutting edges have the same edge width, after a first workpiece is processed, the secondary cutting edges at both sides, due to abrasion, become lower than the middle main cutting edge. In the subsequent process, most of excess material can only be removed by the middle cutting edge, which ultimately results in a higher roughness of a workpiece being machined, and also shortens the service life of a milling cutter. In the improved cutter head structure described above, an edge width of the middle segment of the first cutting edge is smaller than that of the second cutting edges at both sides, which can provide an effective and sufficient cutting force, and improve the surface roughness of the workpiece being machined. Upon the edge width of the middle segment is reduced, the middle segment is worn faster than before, and a uniform wear state of the middle segment similar to that of the second cutting edges is formed, which can ensure uniform cutting in machining, and can maintain good cutting performance and mold roughness when subsequent molds are machined, so as to improve the service life of the tool and maintain a stable workpiece roughness.

In a preferred embodiment, at least one side of the first segment is transitionally connected with a corresponding side of the middle segment by a chamfer, and at least one side of the second segment is transitionally connected with a corresponding side of the middle segment by a chamfer. The above connection is transitioned by a chamfer, so that during the grinding process, bad phenomenon such as wire drawing caused by a sharp point of a right angle can be avoided, the phenomenon that the chips generated during the grinding process are not easily discharged at the corner of the middle segment can also be avoided, and the workpiece roughness is prevented from being higher.

In a preferred embodiment, one side of the first segment is transitionally connected with a corresponding side of the middle segment by a chamfer, and one side of the second segment is transitionally connected with a corresponding side of the middle segment by a chamfer.

In a preferred embodiment, two sides of the middle segment are respectively a first side and a second side, two sides of the first segment are respectively a third side and a fourth side, and two sides of the second segment are respectively a fifth side and a sixth side. The first side and the third side are on a same plane, and the second side is transitionally connected with the fourth side by a chamfer. The second side and the sixth side are on a same plane, and the first side is transitionally connected with the fifth side by a chamfer.

In a preferred embodiment, the edge widths of the first segment and of the second segment are equal to that of the second cutting edges.

In a preferred embodiment, the edge width of the middle segment is in a range from 0.002 mm to 0.1 mm, and the edge widths of the first segment and of the second segment are in a range from 0.005 mm to 0.2 mm.

In a preferred embodiment, the edge widths of the first segment and of the second segment are equal to that of the second cutting edges. The edge widths of the second cutting edges range from 0.005 mm to 0.2 mm.

In a preferred embodiment, a length of the middle segment is in a range from 0.02 mm to 0.2 mm, and a diameter of the cutting body is in a range from 0.2 mm to 20 mm. The length of the middle segment must not be too long. If the length of the middle segment is too long, when sides of a workpiece are machined, the first cutting edge would remove most of excess material, and it is worn faster compared to the second cutting edges, which may finally shorten the service life of the milling cutter.

In a preferred embodiment, the first cutting edge travels through an apex of the cutting body, and the cutting body is symmetrically distributed with respect to the first cutting edge.

In a preferred embodiment, the second cutting edges are symmetrically distributed with respect to the first cutting edge.

In a preferred embodiment, the second cutting edges are each in an arc shape protruding toward the first cutting edge.

In a preferred embodiment, each of the second cutting edges includes a first cutting segment and a second cutting segment. The first cutting segment extends from one side of the cutting body to the top region of the cutting body to connect to one end of the second cutting segment, and the second cutting segment extends from the top region of the cutting body to the other side of the cutting body. The first cutting segment and the second cutting segment are both helical, and a helical direction of the first cutting segment is opposite to that of the second cutting segment.

In a preferred embodiment, a helix angle of the first cutting segment and a helix angle of the second cutting segment both range from 0° to 80°.

In a preferred embodiment, both sides of the first cutting edge are respectively provided with the second cutting edges.

In a preferred embodiment, the cutting body has a diameter of 0.2 mm to 20 mm, an edge width of the first cutting edge and edge widths of the second cutting edges are 0.005 mm to 0.2 mm, and each of the first chip flutes has a depth of 0.05 mm to 1 mm.

In a preferred embodiment, the cutting body, the first cutting edge and the second cutting edges are integrally formed.

In a preferred embodiment, the outer surface of the cutting body is further provided with a plurality of third cutting edges which are respectively disposed at outer sides of the two outermost second cutting edges, and second chip flutes are defined between two adjacent third cutting edges, and between one of the third cutting edges and the second cutting edge adjacent to the one of the third cutting edge.

In a preferred embodiment, the plurality of third cutting edges are symmetrically distributed with respect to the first cutting edge.

In a preferred embodiment, each of the plurality of third cutting edges is helical.

In a preferred embodiment, a cutting edge group comprises the third cutting edges at a same side of the first cutting edge, the cutting edge group is a symmetrical structure, and the third cutting edges at one side of a symmetrical center line of the cutting edge group have a helical direction that is opposite to the third cutting edges at the other side of the symmetrical center line of the cutting edge group.

In a preferred embodiment, each of the third cutting edges has a helix angle of 0° to 80°, and the helix angles of the third cutting edges of the cutting edge group are gradually decreased from both sides to middle.

In a preferred embodiment, one end of each of the plurality of third cutting edge is connected to one of the second cutting edges, and the other end of each of the plurality of third cutting edges is disposed on the outer surface of the cutting body.

In a preferred embodiment, the outer surface of the cutting body is hemispherical.

In a preferred embodiment, the cutting edge portion is made of any one of polycrystalline diamond, monocrystalline diamond, chemical vapor deposited diamond, polycrystalline cubic boron nitride, ceramic, and cemented carbide.

In a preferred embodiment, the cutter head structure further comprises a connecting portion, a rear end surface of the cutting body is connected to a front end of the connecting portion.

In a preferred embodiment, the cutting edge portion is made of the same material as the connecting portion, and the cutting edge portion and the connecting portion are integrally formed.

For the same purpose, a second objective of the invention is to provide a cutting tool including a cutting tool shank and a cutter head structure as described in the first aspect, and a rear end surface of the cutting body is connected to a front end of the cutting tool shank.

The cutting tool according to embodiments of the invention has advantages in comparison with the prior art. In the cutting tool according to embodiments of the invention, the first cutting edge and the second cutting edges respectively disposed at both sides of the first cutting edge are provided on the outer surface of the cutting body, wherein the first cutting edge extends from one side of the cutting body to the top region and then to the other side of the cutting body. During a milling process, cutting is performed by the second cutting edges to remove most of excess material, and the remaining excess material is cut down through pressing process of the first cutting edge. The cutting tool according to embodiments of the invention can achieve roughing before finishing, which can effectively improve the machining accuracy and reduce wear of the first cutting edge to prolong the service life of the first cutting edge. Furthermore, each of the first chip flutes defined between the first cutting edge and the second cutting edges has a width gradually increasing from the top portion to both sides of the cutting body, which can optimize the chip removal capability and prevent cutting chip from being accumulated in the top region of the cutting body to adversely affect forming precision and service life of the cutting tool.

### BRIEF DESCRIPTION OF THE DRAWINGS

FIG. 1 is a schematic structural view of a cutter head structure according to Embodiment 1 of the invention;

FIG. 2 is a top view of FIG. 1;

FIG. 3 is a left view of FIG. 2;

FIG. 4 is a schematic structural view of a cutter head structure according to Embodiment 2 of the invention;

FIG. 5 is a top view of FIG. 4;

FIG. 6 is a partially enlarged view of the section indicated by A in FIG. 5;

FIG. 7 is a front view of the cutter head structure according to Embodiment 2 of the invention;

FIG. 8 is a schematic structural view of a cutter head structure according to Embodiment 3 of the invention; and

FIG. 9 is a schematic structural view of a cutting tool according to an embodiment of the invention.

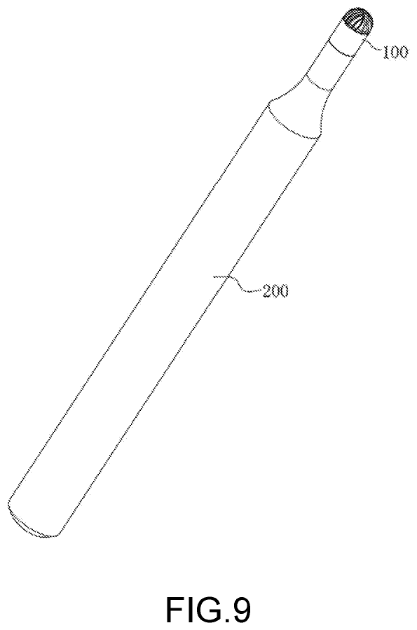

In drawings, cutter head structure 100; connecting portion 1; cutting edge portion 2, 3; cutting body 21, 31; first cutting edge 22, 32; first segment 321; middle segment 322; second segment 323; second cutting edge 23, 33; first cutting segment 231, 331; second cutting segment 232, 332; first chip flute 24, 34; cutting edge group 25; third cutting edge 251, 351; second chip flute 26, 36; third chip flute 27; cutting tool shank 200.

### DESCRIPTION OF THE EMBODIMENTS

The specific embodiments of the invention are further described in detail below with reference to the drawings and embodiments. The following embodiments are intended to illustrate the invention but are not intended to limit the scope of the invention.

In the description of the invention, it should be understood that the terms “front” and “rear” as used in the invention mean that during the use of the cutting tool, one end closer to the workpiece to be machined is “front” and the other end away from the workpiece to be machined is “rear”.

In addition, it should be noted that the term “the apex of the cutting body” as used in the invention refers to the position on the outer surface of the cutting body which is farthest from the cutting tool shank during the use of the cutting tool, and the term “the top region of the cutting body” refers to the region on the outer surface of the cutting body that includes the apex of the cutting body and is closer to the apex of the cutting body.

It should be understood that the terms “first”, “second”, and the like as used in the invention are intended to describe various elements, but the elements should not be limited to these terms, and these terms are only used to distinguish the same type of elements from each other. For example, a “first” element may also be referred to as a “second” element, and similarly, a “second” element may also be referred to as a “first” element, without departing from the scope of the invention.

### Embodiment 1

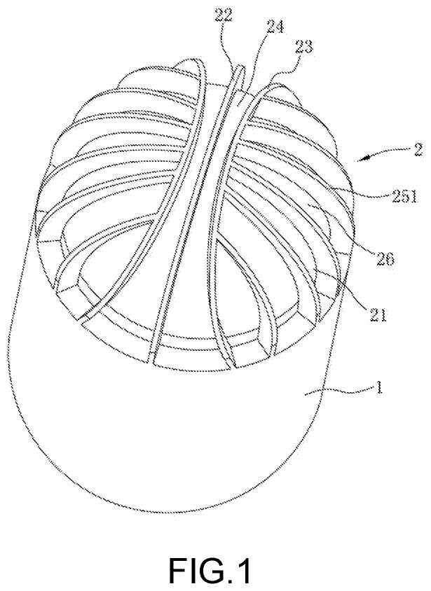

As shown in FIGS. 1 to 3, a cutter head structure 100 according to a preferred embodiment of the invention includes a connecting portion 1 and a cutting edge portion 2 disposed at a front end of the connecting portion 1. The cutting edge portion 2 includes a cutting body 21 fixed to the front end of the connecting portion 1. An outer surface of the cutting body 21 is a curved surface which protrudes forwardly, and the outer surface of the cutting body 21 is provided with a first cutting edge 22 and at least two cutting edges 23. The first cutting edge 22 extends from one side of the cutting body 21 to a top region thereof, and then extends to the other side of the cutting body 21. The second cutting edges 23 are respectively disposed at two sides of the first cutting edge 22. First chip flutes 24 are defined between the first cutting edge 22 and the second cutting edges 23 adjacent thereto, and each of the first chip flutes 24 has a width gradually increasing from the top region of the cutting body 21 to both ends of the cutting body 21.

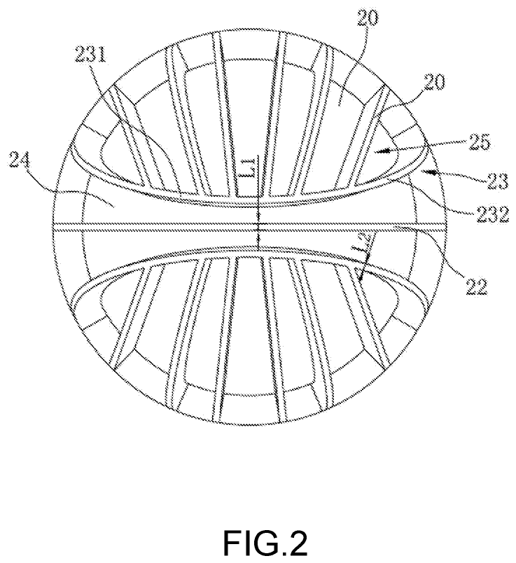

Based on the above technical solution, the cutter head structure 100 is provided with a first cutting edge 22 and a plurality of second cutting edges 23. FIG. 2 shows a top view of the cutter head structure 100. It can be seen from FIG. 2 that the first cutting edge 22 travels through the central region of the cutting body 21, and two second cutting edges 23 are included which are respectively disposed at both sides of the first cutting edge 22. During a milling process, most of excess material is cut down by the second cutting edges 23, and the remaining excess material is finished through pressing action of the first cutting edge 22, thereby ensuring the machining accuracy, improving surface roughness of the machined surface, avoiding wear of the first cutting edge 22 and extending service life of the first cutting edge 22.

In addition, in the embodiment, each of the first chip flutes 24 defined between the first cutting edge 22 and the second cutting edges 23 has a width gradually increasing from the top portion to the both ends of the cutting body 21, so that the cutting chip in the top region of the cutting tool are discharged in time to avoid adverse effects of accumulated cutting chip in the top region of the cutting body 21 on the machining effect and the service life of the cutting tool.

Preferably, in the embodiment, the first cutting edge 22 travels through the apex of the cutting body 21, and the cutting body 21 is symmetrical with respect to the first cutting edge 22. During the milling process, the intermediate portion of the first cutting edge 22 is mainly used to press the remaining excess material, so that the surface roughness and profile of the machined workpiece can be improved.

Specifically, in the embodiment, the second cutting edges 23 are symmetrically distributed with respect to the first cutting edge 22, which can ensure stability when the cutting tool is rotated, and avoid a chattering phenomenon during processing.

As an alternative to the above technical solution, the first cutting edge 22 may deviate from the apex of the cutting body 21, that is, the first cutting edge 22 may be disposed in the manner of deviating from the symmetrical center line of the cutting body 21.

Continue to refer to FIG. 2, each of the second cutting edges 23 is protruded toward the first cutting edge 22 such that the width of each of the first chip flutes 24 gradually increases from middle to both ends.

Specifically, each of the second cutting edges 23 includes a first cutting segment 231 and a second cutting segment 232. The first cutting segment 231 extends from one side of the cutting body 21 to the top region thereof to connect to one end of the second cutting segment 232, and the second cutting segment 232 extends from the top region of the cutting body 21 to the other side of the cutting body 21. The first cutting segment 231 and the second cutting segment 232 are both helical, and a helical direction of the second cutting segment 231 is opposite to that of the second cutting segment 232.

In the technical solution, connection of the first cutting segment 231 and the second cutting segment 231 which have opposite helical directions forms an arc shape protruding toward the first cutting edge 22, so that most of excess material of a workpiece to be machined can be cut down and profile of an machined surface can be ensured.

In the embodiment, the first cutting segment 231 and the second cutting segment 232 each have a helix angle of 0° to 80°. Due to the helix angles, the second cutting edges 23 each have ideal strength, sharpness and cutting force, and the chip removal speed can be guaranteed.

As shown in FIG. 2, the cutting body 21 has a diameter D in a range of 0.2 mm to 20 mm, and the specific diameter is determined depending on the size of the surface to be processed. The distance between two side surfaces of one cutting edge is defined as edge width. The first cutting edge 22 has an edge width L1, and the second cutting edges 23 each have an edge width L2, wherein L1 and L2 are both in a range of 0.005 mm to 0.2 mm. In addition, the first chip flutes 24 each have a depth which is set to 0.05 mm to 1 mm to ensure smooth discharge of cutting chip during the milling process.

Similarly, in order to further increase the cutting force and the machining accuracy and improve the chip removal capability, the outer surface of the cutting body 21 is further provided with a plurality of third cutting edges 251 which are respectively disposed at outer side of the two outermost second cutting edges 23. Second chip flutes 26 are defined between the two adjacent third cutting edges 251 and between one of the third cutting edges 251 and the second cutting edge 23 adjacent to the one of the third cutting edges 251. During the milling process, the third cutting edges 251 and the second cutting edges 23 are simultaneously used to cut down most of excess material of the machined workpiece, and the first cutting edge 22 is used for finishing.

In the embodiment, since the third cutting edges 251 are provided on the cutting body 21, it is possible to avoid the occurrence of saw marks in the processing, so as to secure deep finish machining and play a role of separate cutting.

Preferably, in the embodiment, the third cutting edges 251 is symmetrically distributed with respect to the first cutting edge 22, which can ensure stability when the cutting tool is rotated, and avoid a chattering phenomenon during the milling process.

In the embodiment, each of the third cutting edges 251 has a helical shape. The helical arrangement can ensure a sufficiently large cutting force, thereby improving processing efficiency.

For convenience of description, the third cutting edges 251 disposed at the same side of the first cutting edge 22 are defined to a cutting edge group 25. As shown in FIG. 2, the upper and lower sides of the first cutting edge 22 are respectively provided with a cutting edge group 25. The cutting edge group 25 is of a symmetrical structure, the third cutting edges 251 at one side of the symmetrical center line of the cutting edge group 25 have a helical direction that is opposite to the third cutting edges 251 at the other side of the symmetrical center line of the cutting edge group 25, which can further improve the cutting accuracy and wear resistance of the cutting tool to extend the service life of the cutting tool.

For the same purpose, in the embodiment, each of the third cutting edges 251 has a helix angle of 0° to 80°. The helix angles of the third cutting edges 251 of the cutting edge group 25 are gradually decreased from two sides to middle, which can further improve the wear resistance of the cutting tool and ensure the machining accuracy.

In order to ensure the strength of the cutting tool, the third cutting edges 251 are connected to the second cutting edges 23. In particular, one end of each of the third cutting edge 251 is connected to the corresponding second cutting edge 23, and the other end of each of the third cutting edge 251 is disposed on the outer surface of the cutting body 21.

As an alternative to the aforementioned technical solution, the third cutting edges 251 may extend to the outer side of the connecting portion 1, so that the processing range of the cutting tool can be widened. As an example, both ends of each of the first cutting edge 22 and the second cutting edges 23 also extend to the outer side of the connecting portion 1.

As an example, in the embodiment, both sides of the first cutting edge 22 are respectively provided with six third cutting edges 251. The number of the third cutting edges 251 may be appropriately increased to improve the machining accuracy.

In the embodiment, the outer surface of the cutting body 21 is hemispherical, and the connecting portion 1 has a cylindrical structure which has the same diameter as the cutting body 21.

In the embodiment, the cutting body 21, the first cutting edge 22, the second cutting edges 23 and the third cutting edges 251 are integrally formed, which not only facilitates to form each cutting edge on the outer surface of the cutting body 21, but also ensure the overall wear resistance and integral strength of the cutting edge portion 2.

In the embodiment, the cutting edge portion 2 is preferably made of polycrystalline diamond. Compared with conventional coated milling cutters, a cutting tool with an integrated structure and made of polycrystalline diamond has greatly improved wear resistance, so that the machining accuracy and processing efficiency are effectively improved, and the service life of the cutting tool can be extended.

Likewise, the cutting edge portion 2 may also be made of monocrystalline diamond, chemical vapor deposited diamond, polycrystalline cubic boron nitride, ceramic, cemented carbide, or the like, so that the wear resistance of the cutting tool can be ensured as well.

The cutting edge portion 2 is made of the same material as the connecting portion 1, and the cutting edge portion 2 and the connecting portion 1 are integrally formed to ensure the strength of the entire cutter head structure 100.

### Embodiment 2

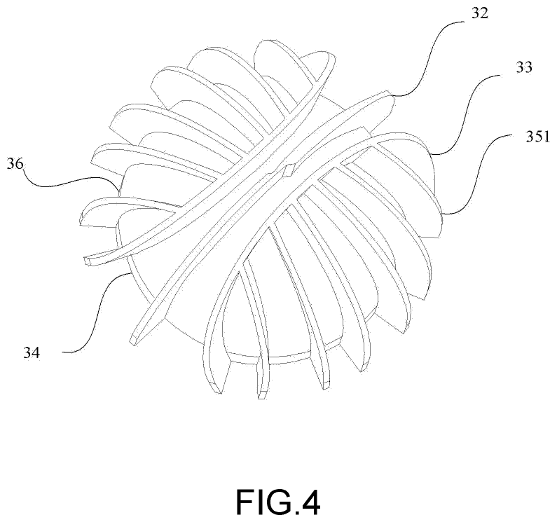

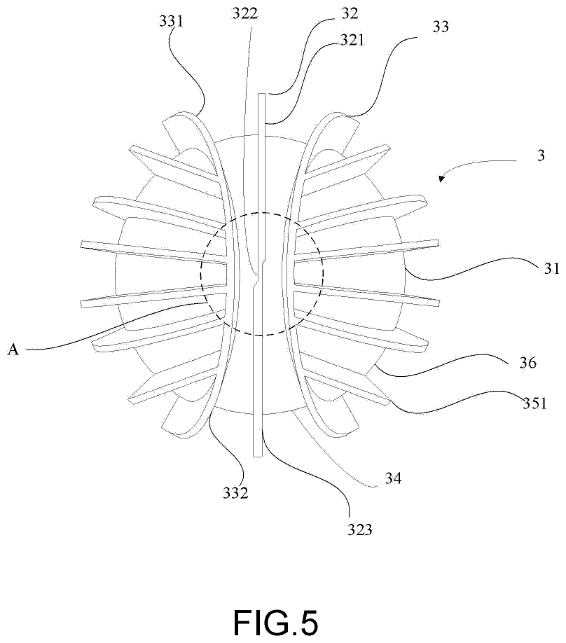

As shown in FIGS. 4 to 7, a cutter head structure according to the embodiment of the invention includes a cutting edge portion 3 including a cutting body 31. An outer surface of the cutting body 31 is a curved surface which protrudes forwardly, and the outer surface of the cutting body 31 is provided with a first cutting edge 32 and at least two cutting edges 33. The first cutting edge 32 extends from one side of the cutting body 31 to a top region thereof, and then extends to the other side of the cutting body 31. The second cutting edges 33 are respectively disposed at both sides of the first cutting edge 32. First chip flutes 34 are defined between the first cutting edge 32 and the second cutting edges 33 adjacent thereto, and each of the first chip flutes 34 has a width gradually increasing from the top region of the cutting body 31 to both ends of the cutting body 31.

The first cutting edge 32 comprises a first segment 321, a middle segment 322, and a second segment 323 connected in sequence. Edge widths of the second cutting edges 33, of the first segment 321, and of the second segment 323 are greater than an edge width of the middle segment 322. The edge width of the middle segment 322 is smaller than that of the second cutting edge 33, of the first segment 321 and of the second segment 323, which can provide an effective and sufficient cutting force, and improve the surface roughness of the workpiece being machined. In addition, upon the edge width of the middle segment 322 is reduced, the middle segment 322 is worn faster than before, and a uniform wear state of the middle segment 322 similar to that of the second cutting edges 33 is formed, which can ensure uniform cutting in machining, and can maintain good cutting performance and mold roughness when subsequent molds are machined, so as to improve the service life of the tool and maintain a stable workpiece roughness.

Further, at least one side of the first segment 321 is transitionally connected with a corresponding side of the middle segment 322 by a chamfer, and at least one side of the second segment 323 is transitionally connected with a corresponding side of the middle segment 322 by a chamfer. The above connection is transitioned by a chamfer, so that during the grinding process, bad phenomenon such as wire drawing caused by a sharp point of a right angle can be avoided, the phenomenon that the chips generated during the grinding process are not easily discharged at the corner of the middle segment can also be avoided, and the workpiece roughness is prevented from being higher.

For example, one side of the first segment is transitionally connected with a corresponding side of the middle segment by a chamfer, and one side of the second segment is transitionally connected with a corresponding side of the middle segment by a chamfer.

In particular, two sides of the middle segment 322 are respectively a first side and a second side, two sides of the first segment 321 are respectively a third side and a fourth side, and two sides of the second segment 323 are respectively a fifth side and a sixth side. The first side and the third side are on the same plane, and the second side is transitionally connected with the fourth side by a chamfer. The second side and the sixth side are on the same plane, and the first side is transitionally connected with the fifth side by a chamfer.

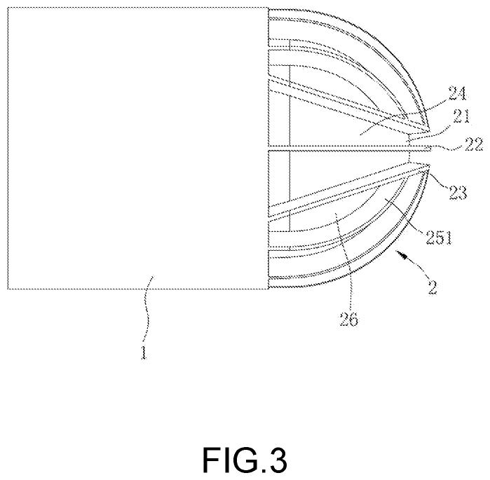

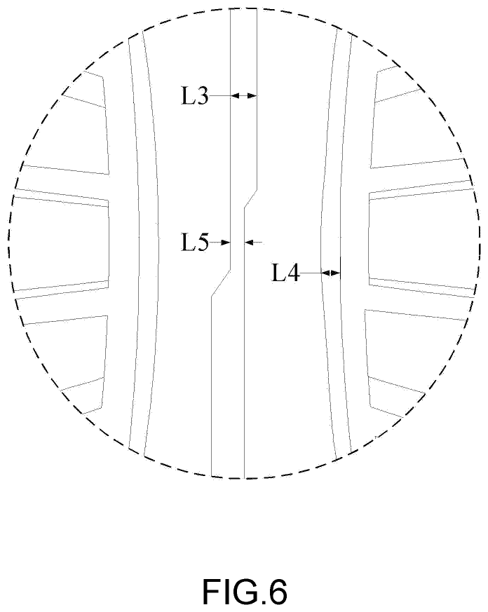

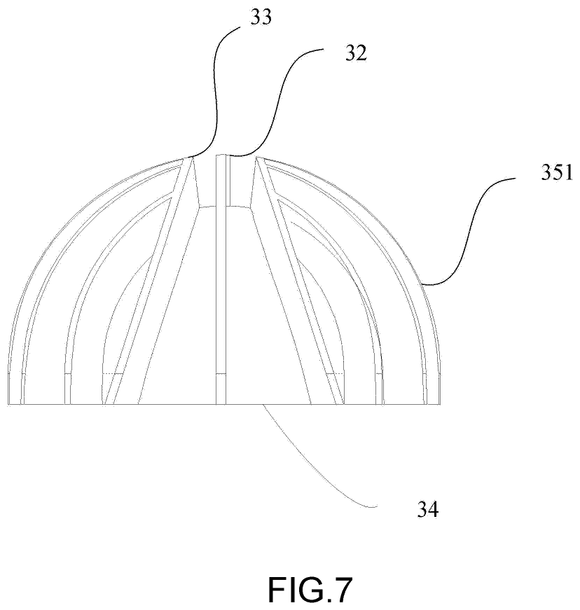

Further, the edge widths of the first segment and of the second segment are equal, and are larger than that of the middle segment. As shown in FIG. 7, the outer surface of the cutting body 31 is a hemispherical surface, the diameter of the cutting body 31 is D, and D=0.2 mm to 20 mm. As shown in FIG. 3, the length of the middle segment 322 is in a range from 0.02 to 0.2 mm, and a specific value is determined according to the size of the surface to be processed. The distance between two sides of a cutting edge is defined as the edge width. As shown in FIG. 6, the edge width of the first segment 321 of the first cutting edge 32 is L3, and the edge width of the second cutting edge 33 is L4. L3 and L4 are equal to each other, and are each in a range from 0.005 mm to 0.2 mm. The edge width of the middle segment 322 is L5, and L5 is in a range from 0.002 mm to 0.1 mm. In addition, the depth of the first chip flute 24 is set to be in a range from 0.05 mm to 1 mm, so as to ensure smooth discharge of waste chips during the milling process.

Except for the above description, the cutter head structure of Embodiment 2 is the same as that of Embodiment 1.

### Embodiment 3

Likewise, this embodiment provides a cutter head structure 100. Specifically, as shown in FIG. 7, it differs from Embodiment 1 only in that the cutting body 21 in this embodiment is provided with six second cutting edges, both sides of the first cutting edge 22 are respectively provided with three second cutting edges, and third chip flutes 27 are defined between the adjacent two second cutting edges.

Similarly, both sides of the first cutting edge 22 may be respectively provided with two, four, or more second cutting edges 23, and the second cutting edges 23 may be arranged at intervals.

### Embodiment 4

The embodiment also proposes a cutter head structure, which differs from Embodiment 2 only in that both sides of the first segment and the second segment are each transitionally connected to a corresponding side of the middle segment by a chamfer, and the other components not mentioned are the same as that Embodiment 2.

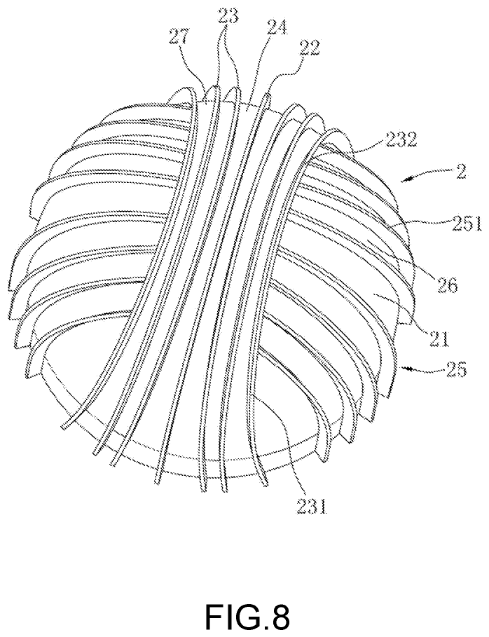

The second aspect of the invention also provides a cutting tool. Specifically, as shown in FIG. 8, the cutting tool comprises a cutting tool shank 200 and a cutter head structure 100 according to any embodiment in the first aspect, wherein the rear end surface of the connecting portion 1 is connected to the front end face of the cutting tool shank 200.

Since the cutting tool according the embodiment of the invention includes the cutter head structure 100 according to any embodiment in the first aspect, it has all the beneficial effects of the cutter head structure 100, which will not be described herein.

In addition, it should be noted that the cutting tool according the embodiment of the invention is mainly used for processing graphite molds. When the cutting tool is rotated, the second cutting edges 23, 33 and the third cutting edges 251, 351 can remove most of excess material of a workpiece to be machined during the rotation and feeding process, and the remaining excess material, about 0.01 mm, is cut down through pressing process of the first cutting edge 22, 32, which achieves roughing before finishing. The cutting chips generated during the milling process are respectively discharged through the first chip flutes 24, 34 and the second chip flutes 26, 36.

In addition, it should be noted that the cutting tool according the embodiment of the invention is mainly used for processing graphite molds. When graphite molds are processed by the cutting tool according the embodiment 1, the cutting tool can continuously process 5 or more than 5 graphite molds, while a conventional tungsten steel coated ball cutter can only process 1 to 2 graphite molds. Moreover, each of the processed graphite molds has highly stable surface roughness which can reach 500 nm or less.

When graphite molds are processed by the cutting tool according the embodiment 2, the cutting tool can continuously process 6 or more than 6 graphite molds, and each of the processed graphite molds has highly stable surface roughness which can reach 1200 nm or less.

In summary, embodiments of the invention provide a cutting tool and a cutter head structure thereof. The cutting body is provided with the first cutting edge and a plurality of second cutting edges disposed at both sides of the first cutting edge. The cutting action of the second cutting edges in combination with the pressing action of the first cutting edge can improve surface roughness of a machined workpiece and extend the service life of the first cutting edge. Each of the first chip flutes defined between the first cutting edge and the second cutting edges has a width gradually increasing from middle to both ends to ensure the chip removal performance and prevent the cutting chip from accumulating in the top region of the cutting body during the milling process, so as to avoid adverse effects on the machining accuracy.

The above is only preferred embodiments of the invention. It should be noted that several improvements and substitutions can be made by those skilled in the art without departing from the technical principles of the invention, which improvements and substitutions should also be considered within the protection scope of the invention.

1. A cutter head structure, comprising a cutting edge portion including a cutting body, an outer surface of the cutting body is a curved surface which protrudes forwardly, and the outer surface of the cutting body is provided with a first cutting edge and at least two second cutting edges;
wherein the first cutting edge extends from one side of the cutting body to a top region of the cutting body and then extends to the other side of the cutting body; the second cutting edges are respectively disposed at two sides of the first cutting edge; first chip flutes are defined between the first cutting edge and the second cutting edges adjacent thereto, and each of the first chip flutes has a width gradually increasing from the top region of the cutting body to both ends of the cutting body.

2. The cutter head structure of claim 1, wherein the first cutting edge comprises a first segment, a middle segment, and a second segment connected in sequence, and edge widths of the second cutting edges, of the first segment, and of the second segment are greater than an edge width of the middle segment.

3. The cutter head structure of claim 2, wherein at least one side of the first segment is transitionally connected with a corresponding side of the middle segment by a chamfer, and at least one side of the second segment is transitionally connected with a corresponding side of the middle segment by a chamfer.

4. The cutter head structure of claim 2, wherein one side of the first segment is transitionally connected with a corresponding side of the middle segment by a chamfer, and one side of the second segment is transitionally connected with a corresponding side of the middle segment by a chamfer.

5. The cutter head structure of claim 2, wherein two sides of the middle segment are respectively a first side and a second side, two sides of the first segment are respectively a third side and a fourth side, and two sides of the second segment are respectively a fifth side and a sixth side; the first side and the third side are on a same plane, and the second side is transitionally connected with the fourth side by a chamfer; the second side and the sixth side are on a same plane, and the first side is transitionally connected with the fifth side by a chamfer.

6. The cutter head structure of claim 2, wherein the edge widths of the first segment and of the second segment are equal to that of the second cutting edges.

7. The cutter head structure of claim 2, wherein the edge width of the middle segment is in a range from 0.002 mm to 0.1 mm, and the edge widths of the first segment and of the second segment are in a range from 0.005 mm to 0.2 mm.

8. The cutter head structure of claim 2, wherein a length of the middle segment is in a range from 0.02 mm to 0.2 mm, and a diameter of the cutting body is in a range from 0.2 mm to 20 mm.

9. The cutter head structure of claim 1, wherein the first cutting edge travels through an apex of the cutting body, and the cutting body is symmetrically distributed with respect to the first cutting edge.

10. The cutter head structure of claim 9, wherein the second cutting edges are symmetrically distributed with respect to the first cutting edge.

11. The cutter head structure of claim 9, wherein the second cutting edges are each in an arc shape protruding toward the first cutting edge.

12. The cutter head structure of claim 11, wherein each of the second cutting edges includes a first cutting segment and a second cutting segment, the first cutting segment extends from one side of the cutting body to the top region of the cutting body to connect to one end of the second cutting segment, and the second cutting segment extends from the top region of the cutting body to the other side of the cutting body;
the first cutting segment and the second cutting segment are both helical, and a helical direction of the first cutting segment is opposite to that of the second cutting segment.

13. (canceled)

14. The cutter head structure of claim 9, wherein the both sides of the first cutting edge are respectively provided with the second cutting edges.

15. The cutter head structure of claim 1, wherein the cutting body has a diameter of 0.2 mm to 20 mm, an edge width of the first cutting edge and edge widths of the second cutting edges are 0.005 mm to 0.2 mm, and each of the first chip flutes has a depth of 0.05 mm to 1 mm.

16. The cutter head structure of claim 1, wherein the cutting body, the first cutting edge and the second cutting edges are integrally formed.

17. The cutter head structure of claim 1, wherein the outer surface of the cutting body is further provided with a plurality of third cutting edges which are respectively disposed at outer sides of the two outermost second cutting edges, and second chip flutes are defined between two adjacent third cutting edges, and between one of the third cutting edges and the second cutting edge adjacent to the one of the third cutting edges.

18. The cutter head structure of claim 17, wherein the plurality of third cutting edges are symmetrically distributed with respect to the first cutting edge.

19. (canceled)

20. The cutter head structure of claim 17, wherein a cutting edge group comprises the third cutting edges at a same side of the first cutting edge, the cutting edge group is a symmetrical structure, and the third cutting edges at one side of a symmetrical center line of the cutting edge group have a helical direction that is opposite to the third cutting edges at the other side of the symmetrical center line of the cutting edge group.

21. The cutter head structure of claim 20, wherein each of the third cutting edges has a helix angle of 0° to 80°, and in the cutting edge group, along a direction from two sides to middle, the helix angles of the third cutting edges are gradually decreased.

22. The cutter head structure of claim 17, wherein one end of each of the plurality of third cutting edge is connected to one of the second cutting edges, and the other end of each of the plurality of third cutting edges is disposed on the outer surface of the cutting body.

23. The cutter head structure of claim 1, wherein the outer surface of the cutting body is hemispherical.

24. The cutter head structure of claim 1, wherein the cutting edge portion is made of any one of polycrystalline diamond, monocrystalline diamond, chemical vapor deposited diamond, polycrystalline cubic boron nitride, ceramic, and cemented carbide.

25. The cutter head structure of claim 1, further comprising a connecting portion, wherein a rear end surface of the cutting body is connected to a front end of the connecting portion.

26. The cutter head structure of claim 25, wherein the cutting edge portion is made of a material same as the connecting portion, and the cutting edge portion and the connecting portion are integrally formed.

27. A cutting tool, comprising a cutting tool shank and a cutter head structure of claim 1, wherein a rear end surface of the cutting body is connected to a front end of the cutting tool shank.
